(19) United States
(12) Patent Application Publication
(10) Pub. No.: US 2015/0288080 A1
(43) Pub. Date: Oct. 8, 2015

(54) HARNESS ASSEMBLY

(71) Applicant: Molex Incorporated, Lisle, IL (US)

(72) Inventors: Yue-You LI, Dongguan (CN); Shui-Neng CHEN, Dongguan (CN)

(73) Assignee: Molex Incorporated, Lisle, IL (US)

(21) Appl. No.: 14/678,159

(22) Filed: Apr. 3, 2015

(30) Foreign Application Priority Data
Apr. 4, 2014 (CN) 201420165817.X

(51) Int. Cl. H01R 4/02; H01B 7/00; H01R 12/53

(52) U.S. Cl. CPC H01R 4/027; H01R 12/53; H01B 7/0045

(57) ABSTRACT

A harness assembly comprises a plurality of wires and a positioning part formed around the wires by means of molding. Each wire comprises an extension section and a naked section provided at a first end of the extension section. Each extension section comprises at least one core conductor and an insulative sheath covering an outer periphery of the at least one core conductor, the naked sections formed by baring and exposing the core conductors outside and are capable of being soldered to soldering pads of the circuit board. The positioning part comprises a main body portion formed around the wires by means of molding and two positioning legs provided on the main body portion in an asymmetry manner, the naked sections of the wires are arranged between the two positioning legs. The first positioning leg corresponds to the first positioning hole of the circuit board, and the second positioning leg corresponds to the second positioning hole of the circuit board.

### REFERENCE To RELATED APPLICATIONS

The Present Disclosure claims priority to prior-filed Chinese Patent Application No. 201420165817.X, entitled “Cable Connector Assembly,” filed on 4 Apr. 2014 with the Chinese Patent Office. The content of the aforementioned Patent Application is incorporated in its entirety herein.

### BACKGROUND OF THE PRESENT DISCLOSURE

The Present Disclosure relates, generally, to a harness assembly, and, more particularly, to a harness assembly which can prevent improper insertion.

Chinese Patent Application No. 02295247.0, the content of which is hereby incorporated herein in its entirety, discloses a cable connector assembly which comprises a base, a cover body, and a cable connecting module. The cover body is assembled on the base. The cable connecting module is assembled between the base and the cover body, and comprises a cable, a plurality of terminals, a plurality of shielding plates and a spacer. The cable has a plurality of wires, the each wire comprises a ground conductor and a signal pair having a first signal conductor and a second signal conductor. The terminals may be mated with a mating connector and may be electrically connected with the ground conductors and the signal conductors. These shielding plates are respectively soldered to the ground conductors, the each signal pair is positioned between the two adjacent shielding plates, the first signal conductor and the second signal conductor are respectively positioned at an upper portion and a lower portion of the two adjacent shield plates. The spacer is integrally formed at a front end of the wires and takes a rectangular parallelepiped configuration. The spacer in this existing design only has function that soldering ends of the wires are bundled and secured so as to facilitate soldering operation, but when the cable connector assembly is to perform alignment and soldering, if the spacer is accidentally rotated by 180°, it is easy to solder the wires in an upper row to soldering pads on a bottom surface of a circuit board and the wires in a lower row to soldering pads on a top surface of the circuit board, so the cable connector assembly does not have the function of preventing improper insertion.

### SUMMARY OF THE PRESENT DISCLOSURE

A technical problem to be resolved by the Present Disclosure is to overcome the deficiencies stated above, and provide a harness assembly which may assure that naked sections of wires are properly inserted into corresponding soldering positions of a circuit board at one time, and in turn improve soldering efficiency and soldering quality.

In view of the above technical problem, the Present Disclosure provides a harness assembly. The harness assembly is suitably soldered to a circuit board, the circuit board being provided with a plurality of soldering pads, a first positioning hole and a second positioning hole thereon. The harness assembly comprises a plurality of wires and a positioning part formed around the wires by means of molding. Each wire comprises an extension section and a naked section provided at a first end of the extension section, each extension section comprising at least one core conductor and an insulative sheath covering an outer periphery of at least one core conductor. The naked sections are formed by baring and exposing the core conductors outside and are correspondingly soldered to the soldering pads of the circuit board. The positioning part comprises a main body portion formed around the wires by means of molding and two positioning legs provided on the main body portion in an asymmetry manner. The naked sections of the wires are arranged between the two positioning legs, which comprise a first positioning leg and a second positioning leg. The first positioning leg corresponds to the first positioning hole of the circuit board, and the second positioning leg corresponds to the second positioning hole of the circuit board.

In one embodiment, the main body portion of the positioning part is formed with a plurality of penetrating holes which are spaced apart from each other and are used to respectively receive the wires, central points of the penetrating holes define a penetrating hole central line. The first positioning leg is offset to one side of the penetrating hole central line and the second positioning leg is offset to the other side of the penetrating hole central line.

In another embodiment, the main body portion of the positioning part is a rectangular parallelepiped shape. The main body portion has a top surface and a bottom surface which are opposite and four side surfaces which are positioned between the top surface and the bottom surface. The two positioning legs are respectively provided at the two opposite side surfaces of the main body portion and extend downwardly out of the bottom surface of the main body portion. The penetrating holes are spaced apart from each other and penetrate the top surface and the bottom surface.

In another embodiment, the positioning part further comprises two standing portions protruding downwardly from the bottom surface of the main body portion, so that a preset gap between a middle part of the bottom surface of the main body portion positioned between the two standing portions and a top surface of the circuit board can be maintained. In another embodiment, the main body portion and the two positioning legs of the positioning part are integrally formed by mean of injection molding.

In another embodiment, the each positioning leg of the positioning part comprises an extension portion extending downwardly out of the main body portion and a grasp portion extending further downwardly out of a distal end of the extension portion. The grasp portion can pass through the corresponding positioning hole of the circuit board and abut against a bottom surface of the circuit board.

In another embodiment, an inner side surface of the extension portion and an inner side surface of the grasp portion of the each positioning leg of the positioning part are flushed with each other to cooperatively form a vertical plane. An outer side surface of the grasp portion of the each positioning leg comprises an insertion guide surface which is small at the bottom and large at the top, a step is formed at a position where the grasp portion and the extension portion of the each positioning leg are jointed, the step can correspondingly abut against the bottom surface of the circuit board.

In another embodiment, the two positioning legs are different from each other in size or outer profile. In another embodiment, the main body portion of the positioning part is formed around joints between the extension sections and the naked sections of the wires by means of molding, so that a part of the extension section and a part of the naked section are encapsulated inside the main body portion, the naked section extends straightforwardly and downwardly out of the main body portion. In an embodiment, second ends of the extension sections of the wires are connected with at least an electrical connector.

In comparison with the public domain, in the harness assembly of the Present Disclosure, in which the positioning part is provided at the first ends of the wires by means of molding and at the same time the two positioning legs are provided on the positioning part in an asymmetry manner and the naked sections of the wires are arranged between the two positioning legs, can assure that the naked sections of the wires are properly inserted into corresponding soldering positions of the circuit board at one time, so that soldering efficiency and soldering quality are improved; moreover, by that the two positioning legs may function as strain relief, can prevent an external force from damaging a soldered dot between the naked sections of the wires and the circuit board.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is an assembled view of an embodiment of a harness assembly of the Present Disclosure and of a circuit board;

FIG. 2 is another assembled view of the harness assembly and the circuit board of FIG. 1;

FIG. 3 is another assembled view of the harness assembly and the circuit board of FIG. 1;

FIG. 4 is an exploded view of the harness assembly of FIG. 1, and the circuit board;

FIG. 5 is another exploded view of the harness assembly of FIG. 1, and the circuit board;

FIG. 6 is a view of a positioning part of the harness assembly of FIG. 1;

FIG. 7 is another view of a positioning part of the harness assembly of FIG. 1; and

FIG. 8 is another view of a positioning part of the harness assembly of FIG. 1.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

Referring to the Figures, the harness assembly 10 comprises a plurality of wires 1, a positioning part 2 secured at first ends 18 of the plurality of wires 1 and a plurality of electrical connector 3, 4, 5 correspondingly connecting second ends 19 of the plurality of wires 1. The harness assembly 10 may be integrally soldered and secured to a circuit board 20. The circuit board 20 has a top surface 208 and a bottom surface 209 which are opposite. The circuit board 20 comprises a plurality of soldering pads 201, a first positioning hole 202 and a second positioning hole 203 which penetrate the top surface 208 and the bottom surface 209.

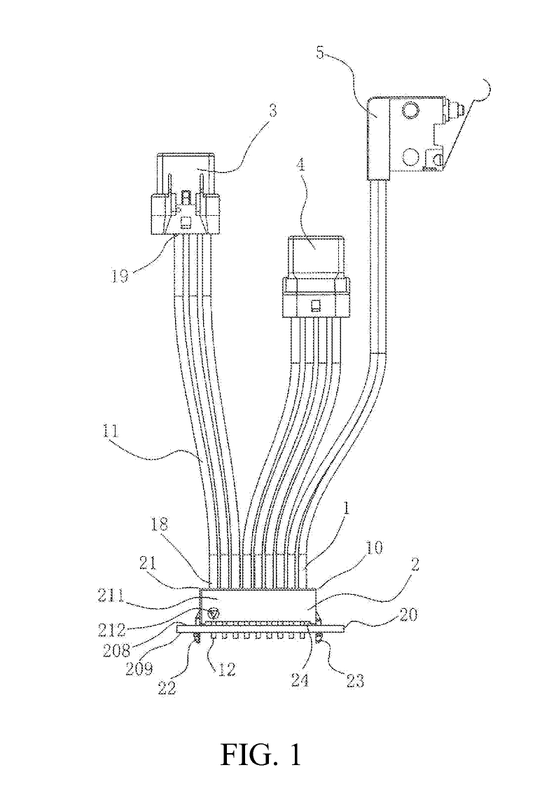

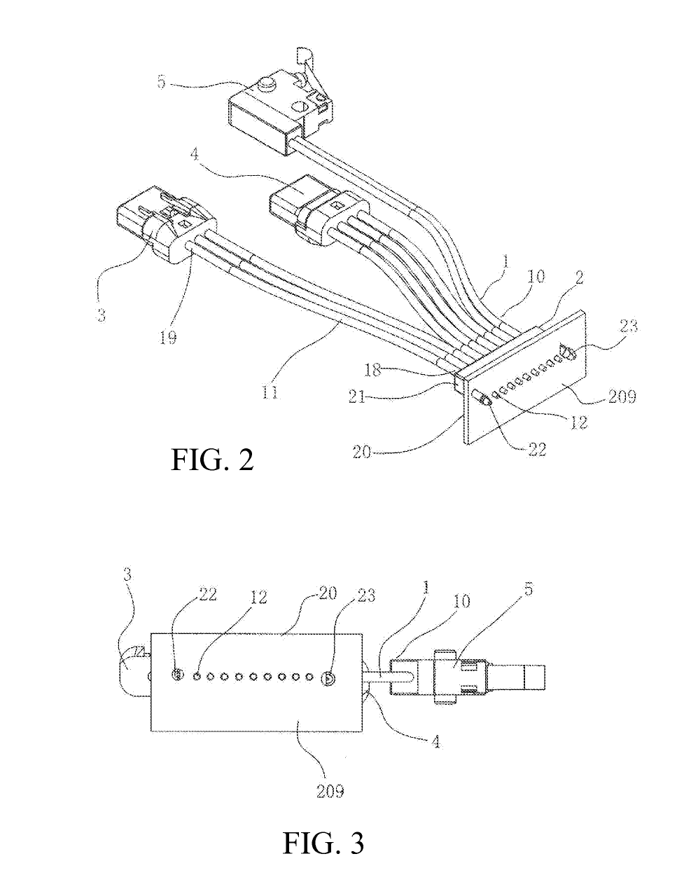

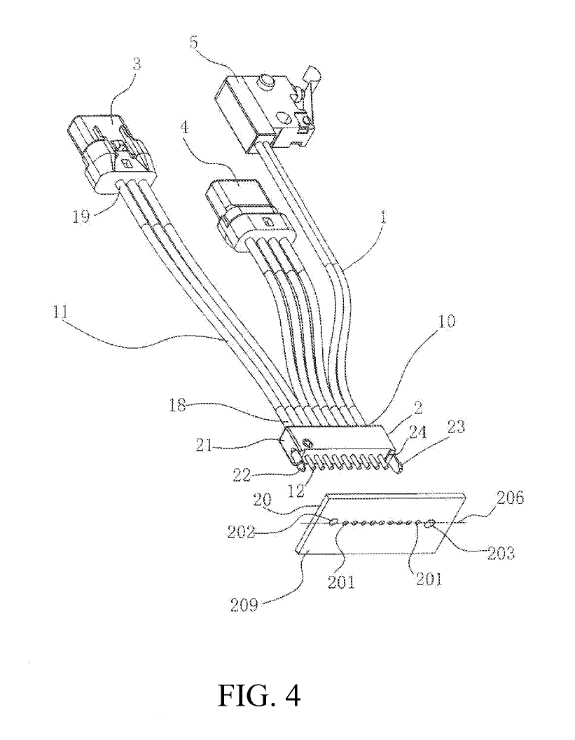

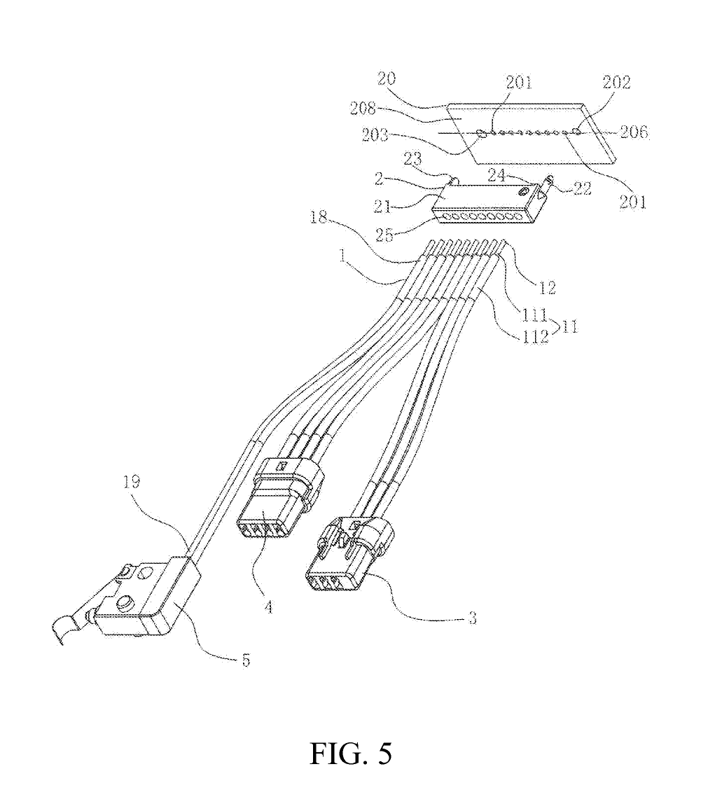

Referring specifically to FIGS. 1-5, the each wire 1 comprises an extension section 11 and a naked section 12 provided at the first end 18 of the extension section 11. The extension section 11 comprises a core conductor 111 and an insulative sheath 112 covering an outer periphery of the core conductor 111, although one wire only has one core conductor in the present embodiment, however in some embodiments, one wire may have two or more core conductors. The naked section 12 is composed of a part of the corresponding core conductor 111 which is exposed outside the insulative sheath 112. These naked sections 12 may be correspondingly soldered to the soldering pads 201 of the circuit board 20. In the present embodiment, these naked sections 12 are preferably spaced apart from each other and arranged in a straight line, correspondingly a soldering pad central line 206 which is composed of the central points of the soldering pads 201 of the circuit board 20 is a straight line. Further, the naked section 12 of the wire 1 extends downwardly in a straight line, the soldering pad 201 of the circuit board 20 is a penetrating hole-type soldering pad, and the naked section 12 of the wire 1 is inserted downwardly into the corresponding penetrating hole-type soldering pad. In other embodiments, the naked section 12 of the wire 1 may also be folded and extended, the soldering pad 201 of the circuit board 20 may be a surface mount type soldering pad, and the naked section 12 of the wire 1 is horizontally mounted and soldered to the corresponding surface mount type soldering pad (not shown).

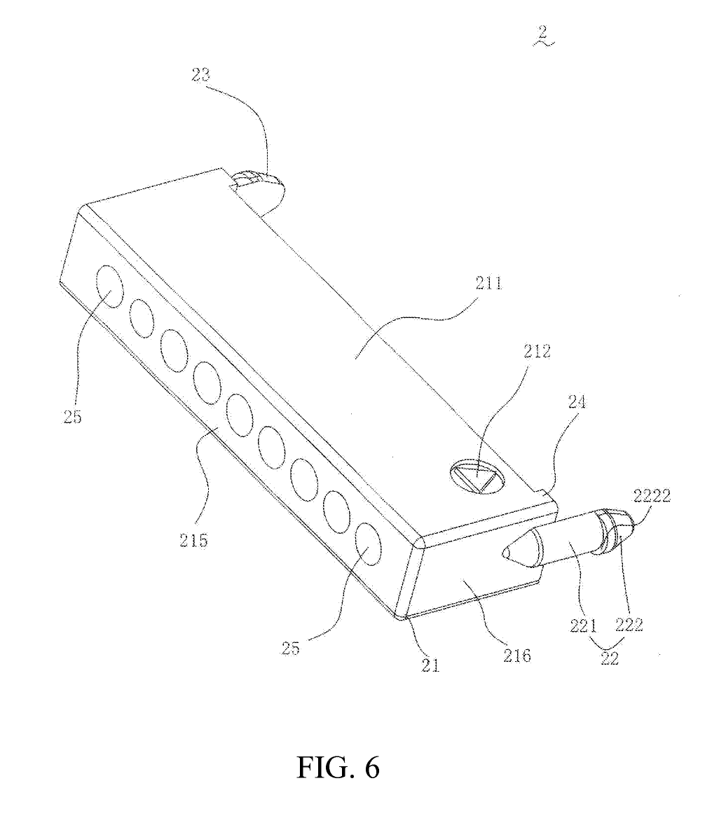

Referring specifically to FIGS. 6-8, the positioning part 2 is integrally formed by means of injection molding. The positioning part 2 comprises a main body portion 21 and a first positioning leg 22 and a second positioning leg 23 which are provided on the main body portion 21. The main body portion 21 is formed around outer peripheries of the first ends 18 of the extension sections 11 of these wires 1 by means of molding so as to maintain a preset interval among these naked sections 12. The naked sections 12 of these wires 1 extend downwardly out of the main body portion 21 and are arranged between the two positioning legs 22, 23. The two positioning legs 22, 23 and the two positioning holes 202, 203 of the circuit board 20 are in one-to-one inserting relationship. Specifically in the present embodiment, the main body portion 21 is preferably formed around outer peripheries of joints between the extension sections 11 and the naked sections 12 of these wires 1 by means of molding, so that a part of the extension section 11 and a part of the naked section 12 are encapsulated inside the main body portion 21, the naked section 12 extends straightforwardly and downwardly out of a bottom surface 219 of the main body portion 21. Such a configuration may prevent the core conductor 111 of the extension section 11 from not being necessarily exposed above the main body portion 21 and from possible short circuit. However, in other embodiments, the main body portion (not shown) may only cover outer peripheries of the extension sections 11 or outer peripheries of the naked sections 12.

The main body portion 21 generally is a rectangular parallelepiped shape. The main body portion 21 has a top surface 215 and a bottom surface 219 which are opposite, a front side surface 211 and a rear side surface 213 which are opposite, and a left side surface 216 and a right side surface 217 which are opposite. A distance between the left side surface 216 and the right side surface 217 defines a length size of the rectangular parallelepiped shape, a distance between the top surface 215 and the bottom surface 219 defines a height size of the rectangular parallelepiped shape, a distance between the front side surface 211 and the rear side surface 213 defines a width size of the rectangular parallelepiped shape. The front side surface 211 is provided with a first mark 212 thereon. The rear side surface 213 is provided with a second mark 214 thereon which is different from the first mark 212. By providing the first mark 212 and/or the second mark 214, it may be easy for a user to properly identify a proper inserting direction of the main body portion 21 with respective to the circuit board 20 and may be beneficial to realize proper insertion between the harness assembly 10 and the circuit board 20. The main body portion 21 is formed with a plurality of penetrating holes 25 thereon which are spaced apart from each other and penetrate the top surface 215 and the bottom surface 219, the each penetrating hole 25 may allow one wire 1 to pass through and extend downwardly out of the bottom surface 219 of the main body portion 21. Central points of these penetrating holes 25 define the penetrating hole central line 26.

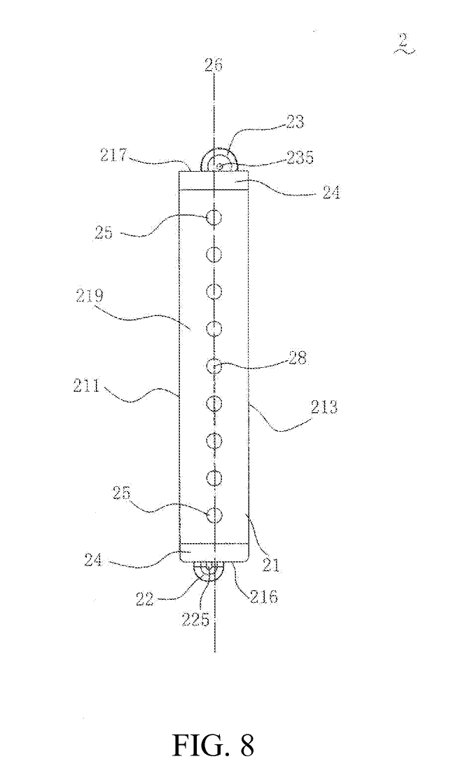

In the present embodiment, the main body portion 21 and the two positioning leg 22, 23 of the positioning part 2 are preferably integrally formed by means of injection molding, however, in other embodiments (not shown), the positioning legs 22, 23 may be separate parts which may be additionally assembled and secured to the main body portion 21. The two positioning legs 22, 23 extend downwardly out of the main body portion 21, and are provided on the main body portion 21 in an asymmetry manner. The asymmetry for the two positioning legs 22, 23 refers to that the first positioning leg 22 and the second positioning leg 23 are different in shape, size and/or position, and the like, or are asymmetric with respect to a central point 28 of the main body portion 21 (see FIG. 8). So that, if the positioning legs 22, 23 are not properly inserted into the positioning holes 202, 203 or are not properly inserted in an inserting direction, the two positioning legs 22, 23 and these naked sections 12 will not be completely inserted into the two positioning holes 202, 203 and these soldering pads 201.

In the present embodiment, the two positioning legs 22, 23 are respectively provided to the left side surface 216 and the right side surface 217 of the main body portion 21 and extend downwardly out of the bottom surface 219 of the main body portion 21. Referring specifically to FIG. 8, a central point 225 of the first positioning leg 22 is offset to one side of the penetrating hole central line 26, a central point 235 of the second positioning leg 23 is offset to the other side of the penetrating hole central line 26, by the above offset provision, it may prevent the two positioning legs 22, 23 from improperly inserting into the two positioning holes 202, 203 from a side where the bottom surface 209 of the circuit board 20 is present. It should be noted that, although offset distances of the two central points 225, 235 and the penetrating hole central line 26 are substantially identical in the present embodiment, however, in some embodiments, the offset distances of the two central points may be different greatly. Furthermore, the first positioning leg 22 and the second positioning leg 23 are different from each other in size, more specifically, the first positioning leg 22 is relatively small in size, the second positioning leg 23 is relatively large in size, so that the second positioning leg 23 cannot be inserted into the first positioning hole 202 which is relatively small in size, thereby ensuring that the first positioning leg 22 can only be correspondingly inserted into the first positioning hole 202 and the second positioning leg 23 can only be correspondingly inserted into the second positioning hole 203 during installation. By combining the two features, i.e., both the first positioning leg 22 and the second positioning leg 23 are offset and are different from each other in size, it can assure that the first positioning leg 22 can only be inserted into the first positioning hole 202 of the circuit board 20 along a proper direction (i.e., a direction from up to down in FIG. 1) and at the same time the second positioning leg 23 can be only inserted into the second positioning hole 203 of the circuit board 20 along a proper direction. It should be noted that, in addition to allow the two positioning legs 22, 23 to be different from each other in size, it may allow the two positioning legs 22, 23 to be different from each other in outer profile (e.g., the first positioning leg 22 is provided as a circle in outer profile, and the second positioning leg 23 is provided as a square in outer profile) so as to attain the effect of preventing improper insertion. Moreover, in a case that it is not necessary to consider that the two positioning legs 22, 23 are prevented from inserting from the bottom surface 209 of the circuit board 20, the two positioning legs 22, 23 may only retain the feature that they are different from each other in size or outer profile, the result of preventing improper insertion may be also attained.

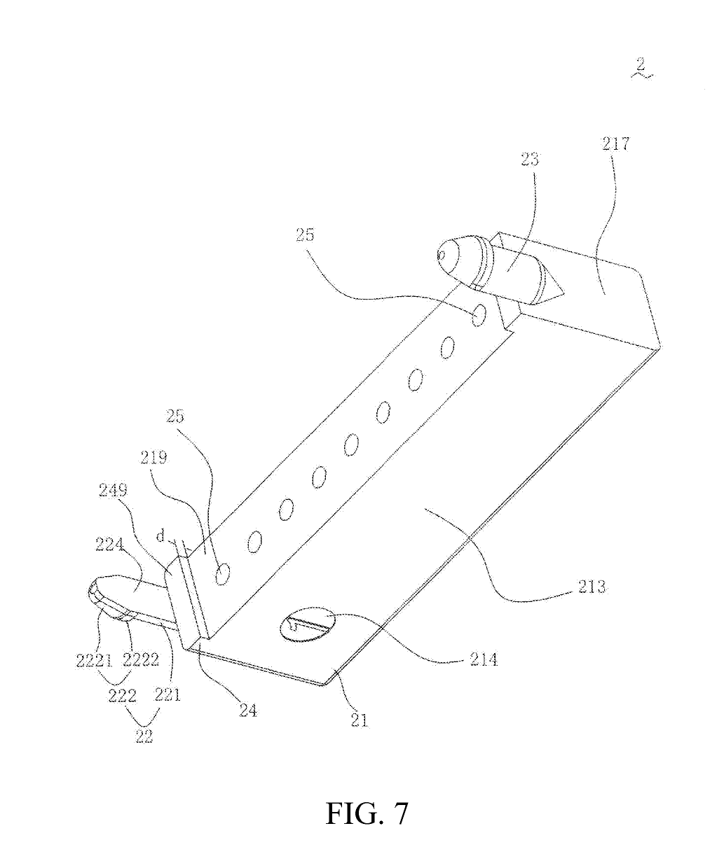

Referring to FIGS. 6-8, the first positioning leg 22 comprises an extension portion 221 extending downwardly out of the left side surface 216 of the main body portion 21 and a grasp portion 222 extending further downwardly out of a distal end of the extension portion 221; the grasp portion 222 can pass through the corresponding first positioning hole 202 of the circuit board 20 and abut against the bottom surface 209 of the circuit board 20 so as to prevent the first positioning leg 22 from withdrawing from the positioning hole 202 (see FIG. 1). Specifically, the first positioning leg 22 is substantially semi-cylinder in shape. An inner side surface of the extension portion 221 and an inner side surface of the grasp portion 222 are flushed with each other so as to cooperatively form a vertical plane 224. An outer side surface of the extension portion 221 is a cylinder surface. An outer side surface of the grasp portion 222 comprises an insertion guide surface 2221, which is small at the bottom and large at the top, so as to facilitate the first positioning leg 22 to be correspondingly inserted into the first positioning hole 202. In the present embodiment, the insertion guide surface 2221 is a conical surface. A step 2222 is formed at a joint position where the grasp portion 222 and the extension portion 221 are jointed. The step 2222 may correspondingly abut against the bottom surface 209 of the circuit board 20, so as to prevent the first positioning leg 22 from withdrawing from the first positioning hole 202 of the circuit board 20. The second positioning leg 23 is similar to the first positioning leg 22 in structure, so the repeated description is omitted. Furthermore, the positioning part 2 may further comprise two standing portions 24 protruding downwardly from two sides of the bottom surface 219 of the main body portion 21 respectively. There is a gap d between the bottom surface 249 of the standing portion 24 and the bottom surface 219 of the main body portion 21 (see FIG. 7). Such a configuration may allow a preset gap d between a middle part of the bottom surface 219 of the main body portion 21 (that is a part where these naked sections 12 specifically pass through) and the top surface 208 of the circuit board 20 to be maintained in a suspended manner so as to prevent solder wicking

In comparison with conventional products, the harness assembly 10 of the Present Disclosure has following beneficial effects: by that the positioning part 2 is provided at the first ends 18 of the harness assembly 10 and the two positioning legs 22, 23 are provided on the positioning part 2 in an asymmetry manner, and the naked sections 12 of these wires 1 are arranged between the two positioning legs 22, 23, a plurality of wires 1 may be combined as an integral unit and it can assure that these naked sections 12 are properly inserted into corresponding soldering positions of the circuit board 20 at one time, so that soldering efficiency and soldering quality are improved; moreover, that the two positioning legs 22, 23 securely grasp the two positioning holes 202, 203 of the circuit board 20, respectively, may function as strain relief, and prevent an external force from damaging a soldered dot between the naked section 12 of the wire 1 and the circuit board 20.

While a preferred embodiment of the Present Disclosure is shown and described, it is envisioned that those skilled in the art may devise various modifications without departing from the spirit and scope of the foregoing Description and the appended Claims.

What is claimed is:

1. A harness assembly, the harness assembly being suitably soldered to a circuit board, the circuit board being provided with a plurality of soldering pads, a first positioning hole and a second positioning hole thereon, the harness assembly comprising:
a plurality of wires, each wire including an extension section and a naked section provided at a first end of the extension section, each extension section including at least one core conductor and an insulative sheath covering an outer periphery of each core conductor, the naked sections being formed by exposing the core conductors outside and being correspondingly soldered to the soldering pads; and
a positioning part formed around the wires by means of molding, the positioning part including a main body portion formed around the wires by means of molding and two positioning legs provided on the main body portion in an asymmetry manner, the naked sections of the wires being arranged between the two positioning legs, the two positioning legs including a first positioning leg and a second positioning leg, the first positioning leg corresponding to the first positioning hole of the circuit board, and the second positioning leg corresponding to the second positioning hole of the circuit board.

2. The harness assembly of claim 1, wherein the two positioning legs are different from each other in size or outer profile.

3. The harness assembly of claim 1, wherein the main body portion of the positioning part is formed around joints between the extension sections and the naked sections of the wires by means of molding, so that a part of the extension section and a part of the naked section are encapsulated inside the main body portion, the naked section extending straightforwardly and downwardly out of the main body portion.

4. The harness assembly of claim 1, wherein second ends of the extension sections of the wires are connected with at least an electrical connector.

5. The harness assembly of claim 1, wherein the main body portion of the positioning part is formed with a plurality of penetrating holes spaced apart from each other and used to respectively receive the wires.

6. The harness assembly of claim 5, wherein central points of the penetrating holes define a penetrating hole central line, the first positioning leg being offset to one side of the penetrating hole central line and the second positioning leg being offset to the other side of the penetrating hole central line.

7. The harness assembly of claim 6, wherein the main body portion of the positioning part is a rectangular parallelepiped shape and includes a top surface and a opposite bottom surface and four side surfaces positioned between the top surface and the bottom surface.

8. The harness assembly of claim 7, wherein the two positioning legs are respectively provided at two opposite side surfaces of the main body portion and extend downwardly out of the bottom surface of the main body portion

9. The harness assembly of claim 8, wherein the penetrating holes are spaced apart from each other and penetrate the top surface and the bottom surface.

10. The harness assembly of claim 9, wherein the positioning part further includes two standing portions protruding downwardly from two sides of the bottom surface of the main body portion so that a preset gap between a part of the bottom surface of the main body portion positioned between two standing portions and a top surface of the circuit board can be maintained in a suspended manner.

11. The harness assembly of claim 10, wherein the two positioning legs are different from each other in size or outer profile.

12. The harness assembly of claim 10, wherein the main body portion of the positioning part is formed around joints between the extension sections and the naked sections of the wires by means of molding, so that a part of the extension section and a part of the naked section are encapsulated inside the main body portion, the naked section extending straightforwardly and downwardly out of the main body portion.

13. The harness assembly of claim 10, wherein second ends of the extension sections of the wires are connected with at least an electrical connector.

14. The harness assembly of claim 1, wherein the main body portion and the two positioning legs of the positioning part are integrally formed by means of injection molding.

15. The harness assembly of claim 14, wherein each positioning leg includes an extension portion extending downwardly out of the main body portion and a grasp portion extending further downwardly out of a distal end of the extension portion, the grasp portion passing through the corresponding positioning hole of the circuit board and abutting against a bottom surface of the circuit board.

16. The harness assembly of claim 15, wherein an inner side surface of the extension portion and an inner side surface of the grasp portion of the each positioning leg are flush with each other to form a vertical plane.

17. The harness assembly of claim 16, wherein an outer side surface of the grasp portion of each positioning leg is an insertion guide surface small at the bottom and large at the top, and a step is formed at a joint position where the extension portion and the outer side surface of the grasp portion are jointed, the step abutting against the bottom surface of the circuit board.

18. The harness assembly of claim 17, wherein the two positioning legs are different from each other in size or outer profile.

19. The harness assembly of claim 17, wherein the main body portion of the positioning part is formed around joints between the extension sections and the naked sections of the wires by means of molding, so that a part of the extension section and a part of the naked section are encapsulated inside the main body portion, the naked section extending straightforwardly and downwardly out of the main body portion.

20. The harness assembly of claim 17, wherein second ends of the extension sections of the wires are connected with at least an electrical connector.
